(19) United States
(12) Patent Application Publication
(10) Pub. No.: US 2020/0339804 A1
(43) Pub. Date: Oct. 29, 2020

(54) PREPARATION METHOD OF FULLY DEGRADABLE POLYGLYCOLIC ACID COMPOSITE PACKAGING MATERIALS

(71) Applicant: REBERET (CHINA) CO., LTD., Zhongshan City (CN)

(72) Inventor: Jiacheng An, Dalian City (CN)

(73) Assignee: REBERET (CHINA) CO., LTD., Zhongshan City (CN)

(21) Appl. No.: 16/527,631

(22) Filed: Jul. 31, 2019

(30) Foreign Application Priority Data
Apr. 28, 2019 (CN) 201910351779.4

(51) Int. Cl. C08L 67/04; C08G 63/06; C08K 3/04; C08K 5/20; C08K 13/02; C08J 5/04; C08J 3/20; B29C 41/50

(52) U.S. Cl. CPC C08L 67/04; B29C 41/24; C08K 3/04; C08K 5/20; C08K 13/02; C08J 5/045; C08J 3/203; B29C 41/50; C08L 2201/06; C08L 2207/324; C08L 2205/025; C08L 2205/035; C08L 2205/16; C08J 2367/04; C08J 2467/04; C08J 2491/00; C08J 2491/06; C08J 2497/02; C08G 63/06

(57) ABSTRACT

The present disclosure provides a fully degradable Polyglycolic acid (PGA) composite packaging material comprises, by weight part, the following: PGA, polycaprolactone, poly(L-lactide-ε-caprolactone), anti-blocking agent, slipping agent, flexibilizer, waterproofing agent, chitosan, reinforced fibers and the like. The present disclosure further provides a preparation method of the fully degradable modified polyglycolic acid composite packaging materials. The present disclosure has the following advantages. The packaging material of the present disclosure has good microbial degradation and hydrolysis. With complete biodegradation, it would result in end-products, water and carbon dioxide, which are environmentally friendly, non-toxic and pose no threat to human- and animal-health. The packaging material of the present disclosure has good mechanical properties, and can fully meet various application requirements of packaging materials. Inexpensive and environmental pollution-free fillers can be added without influence on mechanical properties. The cost can be effectively reduced. The preparation process is simple.

### FIELD OF THE INVENTION

The disclosure relates to the field of medical and packaging materials, specifically to fully degradable polyglycolic acid (PGA) composite packaging materials which can be made with low cost, good toughness and a simple preparation method, as well as preparation methods thereof.

### BACKGROUND OF THE INVENTION

Statistically, the total plastic consumption is 400 million tons per year globally, and the consumption is more than 60 million tons for China, accounting for 15% of the total global consumption. The amount of plastics, which is discarded after use, is about 60%-70% of total consumption. These discarded plastics severely destroy the environment, creating “white pollution”. The “white pollution” not only causes visual pollution to life, but also brings harm to many fields such as agricultural production and ecological cycle.

As the yield of plastics continues to grow, the use thereof continues to expand and the resulting waste is increasing. The used plastics are difficult to degrade and decay in natural environment, resulting in serious environmental pollution. The problem of “white waste” caused by lots of discarded plastic bags and disposable tableware, has become a “century-aged problem”, seriously pollutes the environment and influences people's lives. It would influence the absorption of water and nutrients of crops if the plastics, which are difficult to degrade, are mixed into the soil, leading to crop loss. Even if the plastics are buried, it would occupy the land and would take a hundred years before the plastics can be completely degraded. Lots of scattered plastic materials may also be accidentally eaten animals to cause the death thereof. Previously, an elk in Beijing Nanyuan died due to accidentally eating a plastic bag which flew from a nearby wasteyard. Further, the discarded plastics are easy to form masses or bundles, which can even block water flow, and cause the malfunction of water conservancy facilities or urban facilities which may result in disasters.

Degradable plastics can avoid secondary pollution, and as high-tech and environmental-friendly products, are becoming a hotspot for the research and development around the world. The development not only expands the function of the plastics, but also alleviates environmental contradictions to some extent. Degradable plastics also can be used as supplement for the exhausting oil resources. Therefore, the research, development, popularization and application of the degradable plastics adapt to the requirements of sustainable development of human.

Polyglycolic Acid, also known as poly-hydroxyl acetic acid, is derived from alpha-hydroxyl acid, i.e. glycolic acid. Glycolic acid is produced by the metabolic process of a normal human body. The polymer of glycolic acid is polyglycolic acid (PGA). Polyglycolic acid has a simple and regular linear molecular structure, and is a simple linear aliphatic polyester with high crystallinity. It can form crystalline polymers with generally a crystallinity of 40%-80% and a melting point of about 225° C. Polyglycolic acid is insoluble in commonly used organic solvents, and only is soluble in strong polar organic solvents such as hexafluoroisopropanol. Polyglycolic acid having a high molecular weight can be obtained by loop-opening polymerization. Polyglycolic acid having a molecular weight of more than 10000 can fully meet the strength requirements of absorbable sutures, but has no enough strength for fracture or other internal fixation. When the average molecular weight of polyglycolic acid reaches 20000-145000, the polymer can be drawn into a fibrous form and have a directional molecular arrangement, such that the strength of polyglycolic acid can be enhanced. Such polyglycolic acid can be made into thin films or other different shapes. For biomedical application, polyglycolic acid can be used for surgical sutures, drug-controlled release carriers, fracture fixation materials, tissue engineering scaffolds and suture reinforced materials. When exposed to physical conditions in animal and human bodies, the molecular chains of polyglycolic acid can be broken down, depolymerized, side-group broken and the like by active enzymes, by which polyglycolic acid can be rapidly degraded to water, carbon dioxide and other harmless substances that can be eliminated from the body through the circulatory system in the body and have no toxic and side effects on animal and human bodies. Therefore, polyglycolic acid is often used for the manufacture of surgical sutures, artificial skin and the like in the medical field, and can greatly reduce postoperative complications.

A Chinese patent with publication No. CN101333330 and application No. 200810041435.5 has disclosed a kind of fully degradable polylactic acid (PLA) composite packaging materials and preparation methods thereof. Such composite materials consist of surface-modified woven or non-woven natural fibers, polylactic acid and silane coupling agents. Such polylactic acid composite materials have improved mechanical and thermal properties, and can be completely degraded in the natural environment when they are discarded after use. However, the components of such composite materials have to be extracted from crops and thus have restricted source, resulting in relatively high cost.

### SUMMARY OF THE INVENTION

Regarding the above disadvantages in the prior art, one object of the present disclosure is to provide a fully degradable polyglycolic acid composite packaging material, which has low cost, good toughness and are fully biodegradable.

Another object of the present disclosure is to provide a preparation method for a fully degradable polyglycolic acid composite packaging materials, which has low cost and simple process.

In order to achieve the objects of the present disclosure, the present disclosure adopts the following technical solutions.

A fully degradable polyglycolic acid composite packaging materials, which may comprise, by weight parts:

| | |
|---|---|
| polyglycolic acid (PGA) | 80-100, |
| anti-blocking agent | 0.2-1, |
| slipping agent | 0.05-2, |
| flexibilizer | 1-7, |
| waterproofing agent | 0.5-11 |

The fully degradable polyglycolic acid composite packaging material may further comprise, by weight parts:

| | |
|---|---|
| polycaprolactone | 45-60, |
| poly (L-lactide-ε-caprolactone) | 2-5, |
| pentaerythritol diphosphite | 0.03-0.2, |
| chitosan | 2-6, |
| starch | 15-35, |
| reinforced fibers | 1-5 |

The polyglycolic acid may be particles with an average particle size of 1-5 mm, intrinsic viscosity[η] of 1˜5 g/dl and a molecular weight of 200000-300000.

The polycaprolactone may have a molecular weight of 100000-200000. The polycaprolactone has good compatibility and biodegradability, and can improve the flexibility and extensibility of the composite packaging materials of the present disclosure. In addition, the polycaprolactone can facilitate low temperature molding, delay the biodegradation of materials with single polyglycolic acid, and improve the durability of the materials.

The poly(L-lactide-co-ε-caprolactone) may have a weight-average molecular weight (Mw) of 200000-500000, and have ε-caprolactone units in a mole percentage of 20˜25%. The poly(L-lactide-co-ε-caprolactone) can used to greatly improve the stretch rate and tensile strength.

The anti-blocking agent may be a combination of one or more selected from flake graphite, talcum powder, diatomite or silicon dioxide, preferably is flake graphite. The anti-blocking agent can greatly improve the machinability of the materials.

The flexibilizer may be DuPont Biomax Strong from E.I. Du Pont Company. The flexibilizer can be used to enhance the tenacity of the PGA materials and lower the brittleness thereof. In addition, the flexibilizer can increase the impact strength and melting stability of the PGA materials, and have minimal impact on transparency.

The flexibilizer may also be a composite flexibilizer which may be formulated by nano-calcite, nano-talcum powder and sub-nano fatty acid rare-earth salt in a weight ratio of 30-50:10-20:1-5, preferably in a weight ratio of 35-45:13-18:2-3.

The waterproofing agent may be an animal- or plant- waterproofing agent. The animal waterproofing agent may be a combination of one or more selected from beeswax, beef tallow, whale oil, lanocerin or spermaceti. The plant waterproofing agent may be a combination of one or more selected from palm wax, peanut oil, castor-oil plant, palmitic acid, soybean oil, epoxidized soybean oil, bayberry wax, jojoba oil or hydrogenated vegetable oil. Raw materials may be from conventional animals or plants. It may be biodegradable and environmentally friendly, and may have no influence on the environment, have good water-vapor barrier property, breaking strength, and transparency.

The slipping agent may be oleamide, stearamide or erucyl amide. The slipping agent can be used to reduce the friction coefficient of the film surface, thereby ensuring good subsequent machinability, such as transport performance on a packaging machine. The slipping agent has polar groups, and thus fatty acid amide, which is incompatible with PGA, would migrate to the surface of the film and form a smooth surface after solidification and crystallization, thereby reducing the friction coefficient of the film.

The pentaerythritol diphosphite may be SONOX 627A from Shandong Linyi Sunny Wealth Chemicals Co., Ltd. It can be used to improve the stability of the polymer, especially the thermal stability during the forming process. It also can postpone the degradation of the products, and improve the durability of the products.

The starch may be a combination of one or more selected from corn starch, soybean starch, sweet potato starch and potato starch. The starch can used as an organic filler and have low cost. In addition, the starch is biodegradable, safe and non-toxic.

The chitosan has good biocompatibility and biodegradability, and its degradation products are non-toxic. It can improve antibacterial- and antimicrobial- properties, delay the rapid degradation of polyglycolic acid so as to improve the durability of the products.

The reinforced fibers may be a combination of one or more selected from various natural macromolecular plant fibers such as wood fiber, linen fiber, cotton fiber and bamboo fiber. These fibers have relatively high strength and rigidity, but have small specific gravity. Further, these fibers can degrade in natural environment, have a wide range of sources, no pollution, good bending strength and low elongation.

A method for preparing a fully degradable polyglycolic acid (PGA) composite packaging materials, which may comprise the following steps:

(1) crushing polyglycolic acid, polycaprolactone and poly(L-lactide-ε-caprolactone) into particles with an average particle size of 50-100 μm, and mixing well to obtain a mixed main ingredient;

(2) adding the anti-blocking agent, slipping agent, flexibilizer, waterproofing agent, chitosan, starch and reinforced fiber, and mixing well to obtain a mixed accessory ingredient;

(3) mixing the main ingredient and the accessory ingredient well, and performing press molding with a molding temperature of 160-190° C., a time of 1-8 minutes, and a pressure of 5-20 Mpa to obtain a sheet of 0.3-4 mm, or extruding with an extruder at an extruding temperature of 180-220° C. to obtain a film.

In the above step (3), the mixture may be placed in a mold, and then be press molded at temperature of 170-180° C. and pressure of 8-15 Mpa for 1-3 minutes to obtain a sheet of 0.3-4 mm. Alternatively, the film may be made by tape casting at temperature of 190-200° C.

An ultrasonic treatment may be introduced into the process of press molding and film-tape casting with an extruder, and the ultrasonic wave treatment may be performed with a power of 400-800 W and a frequency of 50-150 KHz.

Compared with the prior art, the present disclosure has the following advantages. The fully degradable polyglycolic acid composite packaging material of the present disclosure has good microbial degradability and hydrolysis. The fully degradable polyglycolic acid composite packaging material of the present disclosure can be completely degraded into low molecular compounds by microorganisms such as bacteria, fungi and algae, in an appropriate and time-limited natural environment. With complete biodegradation, it would result in end-products, water and carbon dioxide, which are environmentally friendly, non-toxic and pose no threat to human- and animal-health. In addition, the fully degradable polyglycolic acid composite packaging material of the present disclosure has good mechanical properties, and can fully meet various application requirements of packaging materials. Further, inexpensive and environmental pollution-free fillers can be added without influence on mechanical properties. The cost can be effectively reduced. The preparation process of the present disclosure is simple.

### DETAILED DESCRIPTION OF THE EMBODIMENTS

The present disclosure will be described in detail below in combination with the following specific embodiments.

Preferably, a fully degradable PGA composite packaging materials comprises, by weight parts:

| | |
|---|---|
| PGA | 80-100 |
| polycaprolactone | 50-55 |
| poly (L-lactide-ε-caprolactone) | 3-4 |
| anti-blocking agent | 0.5-0.8 |
| slipping agent | 0.2-0.8 |
| flexibilizer | 3-5 |
| waterproofing agent | 2-8 |
| pentaerythritol diphosphite | 0.05-0.1 |
| chitosan | 3-4 |
| starch | 20-30 |
| reinforced fibers | 2-4 |

A method for preparing the fully degradable PGA composite packaging materials, comprises following steps:

(1) crushing PGA, polycaprolactone and/or poly(L-lactide-ε-caprolactone) into particles with an average particle size of 60˜80 μm in a low-temperature ultrafine grinder, and mixing well to obtain a mixed main ingredient;

(2) adding the anti-blocking agent, slipping agent, flexibilizer, waterproofing agent, pentaerythritol diphosphite, chitosan, starch and reinforced fibers, then grinding and crushing to obtain particles with an average particle size of 60-80 μm, and mixing well to give a mixed accessory ingredient;

(3) mixing the main ingredient and accessory ingredient well, and performing press molding at a temperature of 170-180° C. and a pressure of 5-12 Mpa for 1-3 minutes, to obtain sheets of 0.3-4 mm; or, extruding a cast or inflation film by an extruder at a temperature of 190-220° C. This film is made of fully biodegradable PGA composite materials. An ultrasonic treatment may be introduced into the process of press molding and film-tape casting with an extruder, and be performed with power of 500-700W and frequency of 60-140 KHz. The various components can make effective intermigration under the action of ultrasonic wave, so as to form a tight structure, improve toughness and strength, and have better transparency.

Preferably, in the above step (3), the above mixture can be placed in a mold, and then be press molded at a temperature of 185° C. and at a pressure of 10 Mpa for 3 minutes. Alternatively, the cast or inflation film can be extruded by the extruder at a temperature of 120° C. to make PGA film, in which, the ultrasonic power is 550 W and the frequency is 100 KHz. Concussion stirring can be effectively performed with acoustic wave. Meanwhile, it can avoid too strong acoustic wave which may lead to cavitation effect producing bubbles. The ultrasonic wave may be generated by an ultrasonic wave-generating generating device which is fixed to an outer panel in a wall-adhering manner, and be transferred to the materials in the cavity through a side wall.

The following tables show the specific embodiments of the fully degradable PGA composite packaging materials of the present disclosure and the experimental test data thereof. Further, the mechanical properties such as tensile strength and breaking elongation are tested according to the method of GB/T4456-1996. Other performance parameters are tested by corresponding existing standards. The expression “Fully Degradation” as defined in the tables means the number of days for the resulting materials being fully biological and environmental degradation, which can be done under the action of a degradation accelerator. The degradation accelerator may be a low molecular weight of PGA (molecular weight being less than 5000). See table 1 and table 2 for details.

TABLE 1
Examples 1-6 of the fully degradable polyglycolic
acid (PGA) composite packaging materials.
Table 1. Ex. 1-6 of the fully degradable PGA
composite packaging materials.

| | Components by Weight Parts | | | | | |
|---|---|---|---|---|---|---|
| Ingredients | Ex. 1 | Ex. 2 | Ex. 3 | Ex. 4 | Ex. 5 | Ex. 6 |
| PGA | 100 | 95 | 90 | 85 | 95 | 80 |
| Flake Graphite | 0 | 0 | 0 | 0 | 0 | 1 |
| Oleamide | | | | 1 | | |
| Erucyl Amide | | | | | 1 | 1 |
| Composite Flexibilizer | | | | | 4 | 7 |
| DuPont | | | 4 | 4 | | |
| Lanocerin | | | 3 | 2 | | 2 |
| Whale Oil | | 5 | 3 | 3 | | 3 |
| Epoxidized Soybean | | | | 5 | | |
| Oil | | | | | | |
| Palm Wax | | | | | | 6 |
| Tensile Strength, MPa | 215 | 218 | 283 | 275 | 286 | 298 |
| Breaking Elongation, % | 23 | 22 | 43 | 45 | 44 | 46 |
| Bending Strength, MPa | 121 | 124 | 188 | 192 | 196 | 191 |
| Fully Degradation/days | 25 | 27 | 28 | 27 | 26 | 29 |

In the above table, “DuPont” means DuPont Biomax Strong from E.I. Du Pont Company.

TABLE 2
Examples 7-12 of the fully degradable polyglycolic
acid (PGA) composite packaging materials.
Table 2. Ex. 7-12 of the fully degradable PGA
composite packaging materials.

| | Components by Weight Parts | | | | | |
|---|---|---|---|---|---|---|
| Ingredients | Ex. 7 | Ex. 8 | Ex. 9 | Ex. 10 | Ex. 11 | Ex. 12 |
| PGA | 92 | 81 | 95 | 90 | 85 | 96 |
| polycaprolactone | 54 | 46 | 59 | 50 | 55 | 53 |
| Poly(L-lactide-ε- | 3.3 | 3 | 4.5 | 3.5 | 4 | 3 |
| caprolactone) | | | | | | |

Anti-blocking agent

| | | | | | | |
|---|---|---|---|---|---|---|
| Silicon Dioxide | 0.5 | | | | 0.7 | 08 |
| Flake Graphite | | 0.3 | 0.9 | 0.6 | | |

Slipping agent

| | | | | | | |
|---|---|---|---|---|---|---|
| Stearamide | 0.8 | | 1.9 | | | 1.5 |
| Oleamide | | 0.06 | | | | |
| Erucyl Amide | | | | 1 | 1.2 | |

Flexibilizer

| | | | | | | |
|---|---|---|---|---|---|---|
| DuPont | 2.5 | 2 | | | | 4 |
| Composite | | | 6 | 3 | 5 | |
| Flexibilizer | | | | | | |

Waterproofing Agent

| | | | | | | |
|---|---|---|---|---|---|---|
| Lanocerin | 3 | | 2 | 3 | | 2 |
| Whale Oil | | 0.6 | 3 | 3 | | 2 |
| Palm Wax | | | 3 | | 2 | 2 |
| Soybean Oil | | | 2 | | 3 | 2 |
| Pentaerythritol | 0.04 | 0.15 | 0.08 | 0.12 | 0.09 | 0.18 |
| Diphosphite | | | | | | |
| Chitosan | 2.5 | 3 | 5.5 | 4 | 5 | 4 |
| Starch | 21 | 16 | 34 | 20 | 2 | 30 |

Reinforced Fibers

| | | | | | | |
|---|---|---|---|---|---|---|
| Fibrilia | | | 4.5 | 3 | | 3.5 |
| Bamboo Fiber | | 2 | | | 4 | |
| Wood Fiber | 2.5 | | | | | |
| Tensile Strength, MPa | 310 | 331 | 346 | 355 | 350 | 323 |
| Breaking Elongation, % | 92 | 91 | 105 | 96 | 102 | 99 |
| Bending Strength, MPa | 235 | 242 | 248 | 229 | 238 | 239 |
| Fully Degrade/days | 33 | 32 | 31 | 33 | 32 | 34 |

In the above table, “DuPont” means DuPont Biomax Strong from E.I. Du Pont Company.

The poly(L-lactide-ε-caprolactone) used herein can be obtained by putting L-lactide and ε-caprolactone in toluene in a molar ratio of 75:25, under the catalysis of stannous octoate, drying at 40° C., 133 Pa for 24 hours, and then lowering the pressure to less than 0.5 Pa to melt and copolymerize under a constant temperature. This present disclosure can, with a small addition number of poly(L-lactide-ε-caprolactone), significantly improve the mechanical properties such as elongation and elastic strength of PGA, without changing the biodegradability thereof.

PGA is mainly be obtained by the polycondensation of glycolic acid, glycolic acid ester, glycolide and other raw materials under the action of catalysts. At present, glycolic acid can be produced by the hydrogenation and hydrolysis of an intermediate product, dimethyl oxalate, in an ethylene glycol project. PGA with excellent performance can be obtained at very low cost, in the rapid scale promotion of coal-based ethylene glycol.

As can be seen from the above examples, the fully degradable PGA composite packaging materials of the present disclosure have excellent mechanical properties, as well as good microbial degradation and hydrolysis. Besides, the materials and preparation process have low cost, and thus can effectively replace the existing plastic packaging materials.

The above are only preferred embodiments of the present disclosure, and are not intended to limit the scope of the present disclosure. That is, simple equivalent changes and modifications made within the scope of present disclosure and the contents cited herein, are still fall in the scope of the present disclosure.

The embodiments of the invention in which an exclusive property or privilege is claimed are defined as follows:

1. A fully degradable polyglycolic acid composite packaging material, comprising, by weight parts, the following:

| | |
|---|---|
| polyglycolic acid | 80-100, |
| anti-blocking agent | 0.2-1, |
| slipping agent | 0.05-2, |
| flexibilizer | 1-7, |
| waterproofing agent | 0.5-11 |

2. The fully degradable polyglycolic acid composite packaging material according to claim 1, further comprising, by weight parts, the following:

| | |
|---|---|
| polycaprolactone | 45-60, |
| poly (L-lactide-ε-caprolactone) | 2-5, |
| pentaerythritol diphosphite | 0.03-0.2, |
| chitosan | 2-6, |
| starch | 15-35, |
| reinforced fiber | 1-5 |

3. The fully degradable polyglycolic acid composite packaging material according to claim 1, wherein the poly(L-lactide-ε-caprolactone) has a weight-average molecular weight of 200,000-500,000, and has ε-caprolactone units in a mole percentage of 20-25%.

4. The fully degradable polyglycolic acid composite packaging material according to claim 1, wherein the anti-blocking agent is flake graphite, talcum powder, diatomite or silicon dioxide.

5. The fully degradable polyglycolic acid composite packaging material according to claim 1, wherein the flexibilizer is DuPont Biomax Strong from E.I. DuPont Company, or a composite flexibilizer which is made of nano-calcite, nano-talcum powder and subnano fatty acid rare-earth salt in a weight ratio of 30-50:10-20:1-5.

6. The fully degradable polyglycolic acid composite packaging material according to claim 1, wherein the waterproofing agent is an animal- or plant-waterproofing agent, wherein the animal waterproofing agent is one or more of beeswax, beef tallow, whale oil, lanocerin or spermaceti, and the plant waterproofing agent is one or more of palm wax, peanut oil, castor-oil plant, palmitic acid, soybean oil, epoxidized soybean oil, bayberry wax, jojoba oil or hydrogenated vegetable oil.

7. The fully degradable polyglycolic acid composite packaging material according to claim 1, wherein the slipping agent is oleamide, stearamide or erucyl amide.

8. The fully degradable polyglycolic acid composite packaging material according to claim 1, wherein the reinforced fiber is one or more of wood-, linen-, cotton- or bamboo-fiber.

9. A method for preparing the fully degradable polyglycolic acid composite packaging material according to claim 1, comprising the following steps:
(1) crushing polyglycolic acid, polycaprolactone and poly(L-lactide-ε-caprolactone) into particles with an average particle size of 50-100 μm, and mixing well to obtain a mixed main ingredient;
(2) adding the anti-blocking agent, slipping agent, flexibilizer, waterproofing agent, pentaerythritol diphosphite, chitosan, starch and reinforced fiber, then grinding, milling, and mixing well to obtain a mixed accessory ingredient; and
(3) mixing the main ingredient and the accessory ingredient well, and performing press molding with a temperature of 160-190° C., a time of 1-8 minutes and a pressure of 5-20 Mpa to make a sheet of 0.3-4 mm, or extruding with an extruder at an extruding temperature of 180-220° C. to obtain a film.

10. The method for preparing the fully degradable polyglycolic acid composite packaging material according to claim 9, wherein an ultrasonic wave treatment is introduced into the process of press molding and film-tape casting with an extruder, and wherein the ultrasonic wave treatment is performed with a power of 400-800 W and a frequency of 50-150 KHz.
